(19) United States
(12) Patent Application Publication
(10) Pub. No.: US 2007/0099524 A1
(43) Pub. Date: May 3, 2007

(54) Composite for a Panel Facing

(76) Inventor: John Porter, St. Catharines (CA)

Correspondence Address: DUANE MORRIS, LLP;IP DEPARTMENT, 30 SOUTH 17TH STREET, PHILADELPHIA, PA, 19103-4196, US

(21) Appl. No.: 11/536,293

(22) Filed: Sep. 28, 2006

Related U.S. Application Data
(60) Provisional application No. 60/722,095, filed on Sep. 29, 2005.

(51) Int. Cl. B32B 5/26; B32B 27/12; D04H 1/54; D04H 1/00; B32B 27/04

(52) U.S. Cl. 442/38; 442/394; 442/381; 442/409; 442/414; 442/2; 442/35

(57) ABSTRACT

A composite has a fibrous layer bonded to an outer side of an impermeable barrier layer. The composite is assembled on a panel composition that provides a panel substrate. The barrier layer isolates the fibrous layer from the panel composition. The fibrous layer is exposed from the barrier layer and is free of the panel composition to adhere another material to the panel. Alternatively, the composite has another fibrous layer bonded to an inner side of the barrier layer for embedding in the panel composition.

### CROSS REFERENCE TO RELATED APPLICATIONS

This application claims the benefit of provisional application No. 60/722,095 filed Sep. 29, 2006.

### FIELD OF THE INVENTION

The present invention relates to a composite for a panel facing, and a structural panel on which the composite is assembled to provide a panel facing.

### BACKGROUND

U.S. Pat. No. 6,743,742 discloses a panel having a nonwoven fibrous mat. The mat provides a permeable fibrous surface for adhering another material to the panel. The fibers of the mat are assembled to the panel, by being partially imbedded in a melt phase panel composition that flows to surround individual fibers of the mat. Thereafter, the panel composition is solidified to hold the fibers in place. However, the fibers can sink into the melt phase panel composition and become enveloped, particularly when the panel composition is of low viscosity. Further, the melt phase panel composition can wick among the fibers, particularly when the fibers are wetted by a panel composition of high wettability. Thus, the fibers at the panel surface tend to become enveloped by the panel composition, which reduces the number of fibers protruding from the panel composition for adhering another material to the panel.

The surface chemistry of the fibrous mat is considered to be phobic to either the melt phase panel composition, or to other materials that intend to adhere to the fibrous mat, when the materials have difficulty forming chemical bonds therebetween. For example, a fibrous mat of polyolefin composition, for example, polyethylene or polypropylene, will chemically bond to a panel composition of the same chemical family, while being phobic to many compositions that are not of the same chemical family. In turn, the surface chemistry of other materials that are intended to adhere to the fibrous mat is phobic to the polyolefin composition of the fibrous mat. A desirable fibrous mat would be capable of forming chemical bonds with materials of a different chemical family as that of the fibrous mat.

U.S. Pat. No. 4,242,406 discloses a structural laminate fabricated by applying a plastic finish coat against a mold, followed by applying a reinforcing layer having chopped glass mixed in a stream of fluid resin, and applying a bonding layer of glass fibers that are dry sprayed onto the fluid resin while the fluid resin is still tacky. The glass fibers are coated with a resin of the same chemical family as the fluid resin to promote adhesion therebetween. The glass fibers are intended to protrude from the fluid resin to become enveloped in an exterior layer of gypsum plaster that is sprayed or cast onto the protruding glass fibers. The structural laminate lacks a barrier layer to prevent the resin coated glass fibers from sliding into the fluid resin and become enveloped, particularly when the glass fibers are coated with a resin of the same chemical family as the fluid resin to promote adhesion therebetween. The glass fibers tend to become enveloped by the fluid resin, which reduces the number of fibers protruding from the fluid resin for adhering the gypsum plaster to the structural laminate.

In U.S. Pat. No. 5,624,386, a structural bar is reinforced by wrapping the bar with a flexible band having a first layer of fibers extending in one direction, and another layer of fibers extending in another direction. Further, the fibers in the flexible band are enveloped by a resin of high flexural modulus, which confines the fibers and prevents the fibers from protruding from the flexible band.

In U.S. Pat. No. 6,743,742, a panel is formed by solidifying a thermosetting, or thermoset, resin composition. Partially embedding a fibrous mat in a melt phase thermoset panel composition would encounter difficulties. The viscosity of the melt phase thermoset is difficult to control, because the viscosity disproportionately increases when its temperature moderately decreases. Thus, the melt phase of the thermoset is attained solely when accompanied by a low viscosity, or high melt index, which promotes sinking of the fibers into the resin composition. Further, the melt phase is known for its high wettability, which promotes wicking among the fibers of the mat. The fibers of the fibrous mat would tend to be enveloped by the melt phase thermoset, which resists the adherence of other materials to the panel.

To avoid enveloping the fibrous mat with the melt phase panel composition, it would be desirable to provide a composite having a fibrous mat on a barrier layer, such that, when the composite is assembled to a panel composition, the barrier layer is between the fibrous mat and the melt phase panel composition, wherein the barrier layer shields the fibrous layer from contact with the panel composition. The fibrous layer is exposed from the barrier layer and is available for adherence of other materials to the panel.

To overcome difficulties in adhering a panel composition to other materials, it would be desirable to provide a composite having a fibrous layer bonded to a side of a barrier layer, wherein the fibrous layer is chemically compatible with the other materials to bond to the other materials, and wherein at least the side of the barrier layer is impermeable to the panel composition and isolates the fibrous layer from contact or engagement with the panel composition.

Another desirable composite construction would have another, or farther fibrous layer bonded to another side of the barrier layer, wherein, the further fibrous layer is chemically compatible with the barrier layer and with the panel composition to bond with both the barrier layer and the panel composition.

### SUMMARY OF THE INVENTION

According to an embodiment of the invention, a composite for assembly to a panel includes a fibrous layer bonded to a side of a barrier layer, wherein the barrier layer is impermeable to the chemical composition of the panel and isolates the fibrous layer and the fibers in the fibrous layer from contact with the panel composition such that the fibers of the fibrous layer are exposed from the side of the barrier layer and are free of the panel composition to adhere another material to the panel. Advantageously, the number of fibers available to adhere another material to the panel is not reduced by being enveloped in the panel composition. Further, the fibers are not limited to the same chemical family as that of the panel composition. Further, the fibers are not confined within a resin layer.

According to another embodiment of the invention, another fibrous layer is bonded to another side of the barrier layer, and is chemically compatible with the corresponding another side of the barrier layer and with the panel composition to bond with both the barrier layer and the panel.

Another embodiment of the present invention includes an open mesh scrim bonded to the barrier layer.

Further, according to the invention, a method of making a panel, includes, fabricating a composite for a panel facing having a fibrous layer bonded to a barrier layer; and imbedding at least partially the barrier layer in a panel composition of the panel, wherein the barrier layer separates the panel composition from the fibrous layer to prevent engagement therebetween, and at least a portion of the fibrous layer is exposed from the barrier layer and is free of the panel composition to adhere other materials to the panel.

According to a further embodiment of the invention, a panel includes, a polymeric resinous panel composition; and a composite for a panel facing comprised of, a barrier layer and at least one fibrous layer to adhere other materials to the panel, wherein, the barrier layer is between the fibrous layer and the panel composition, the fibrous layer is bonded to the barrier layer, and fibers in the fibrous layer have portions thereof at least partially exposed from the barrier layer and is free of the panel composition to adhere other materials to the panel. Advantageously, the fibrous layer and the resinous composition of the panel substrate are separated by the barrier layer therebetween, such that, the barrier layer prevents contact between the fibrous layer and the resinous composition.

According to another embodiment of the invention, a composite includes, a barrier layer having an extruded first layer of a first thermoplastic composition on one side and an extruded second layer of a second thermoplastic composition on another side, a first fibrous layer covering the first layer and melt bonded to the first thermoplastic composition, and a second fibrous layer covering the second layer and melt bonded to the second thermoplastic composition.

These and other embodiments of the invention will now be described by way of example with reference to the accompanying drawings.

### BRIEF DESCRIPTION OF THE DRAWINGS

FIG. 1A is an enlarged cross section view of a portion of a composite.

FIG. 1B is a fragmentary view of a portion of FIG. 1A.

FIG. 2 is a cross section view of another embodiment of a composite

FIG. 3 is a cross section view of another embodiment of a composite

FIG. 4 is a cross section view of another embodiment of a composite

FIG. 5 is a schematic view of an apparatus for making a curvilinear composite.

FIG. 6 is a schematic view of a curvilinear composite with parts broken away.

FIG. 7 is a fragmentary section view of an embodiment of an attached composite.

FIG. 8 is a fragmentary section view of another embodiment of a composite.

FIG. 9 is a fragmentary section view of yet another embodiment of a composite.

FIG. 10 is a fragmentary section view of yet another embodiment of a composite.

### DETAILED DESCRIPTION

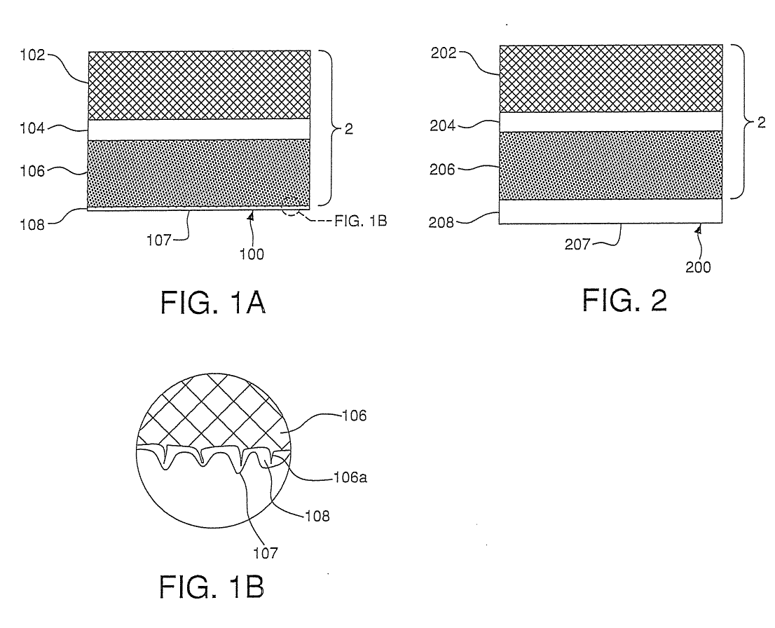

FIG. 1A discloses an embodiment of a flexible or rigid composite 2. FIG. 1A further discloses an exemplary panel 100 on which the composite 2 is assembled to provide a panel facing. The composite 2 has at least one exemplary fibrous layer 102 melt bonded to, and covering, an outer side of an exemplary barrier layer 104. An inner side of the barrier layer 104 faces toward a polymeric panel composition 108 that comprises a panel substrate to which the composite 2 is melt bonded. The barrier layer 104 is selected with a polymer composition capable of forming a melt bond with the polymeric panel composition 108. According to an embodiment of the invention, the panel composition 108 has a surface when in melt phase forms a melt bond with the composite 2. Thereafter, the surface of the panel composition 108 solidifies to retain the composite 2 in place.

A melt bond is formed at the interface of two, chemically compatible materials, wherein one of the materials comprises a polar ionized composition with a melt phase surface, and the other of the materials in solid phase has a surface, alternatively a partially melted surface, with the capability to form covalent chemical bonds with the melt phase surface of the polar ionized composition. The melt phase surface is then solidified to a solid phase to form a solidified melt bond that affixes or retains the two chemically compatible materials.

A melt bond is formed in an alternative manner at the interface of two, chemically compatible materials, when one of the materials has a melt phase surface, and the surface of the second material in solid phase is of low phobicity to the adherent macromolecular morphology formed by the melt phase surface. Alternatively, a partially melted surface is formed on the second material in solid phase, and is of similar low phobicity. The melt phase is then solidified to a solid phase, by complete polymerization, solvent drying or cooling, as appropriate according to the chemical composition being solidified from the melt phase, to form a solidified melt bond between the two materials.

The melt phase referred to herein comprises; a fluent thermoplastic composition at a temperature above its melt temperature, or fluent thermoset composition in a prepolymerized melt phase at a temperature above its melt temperature. The melt temperature further refers to a glass transition temperature of a crystalline polymeric composition. The melt phase includes, but is not limited to, a prepolymerized melt phase, a heat induced melt phase or a chemically induced melt phase. A prepolymerized melt phase refers to a thermoset resin composition or a thermoplastic resin composition dissolved in a compatible solvent prior to complete polymerization of the composition. A heat induced melt phase refers to a thermoplastic composition in solid phase to which heat is applied to heat the surface of the composition at least to its melt temperature to provide a melt phase surface.

According to an embodiment of the invention, the barrier layer 104 is chemically compatible with the panel composition 108 and with the fibers of the fibrous layer 102 to form respective melt bonds therewith. According to another embodiment, a chemically compatible adhesive material forms a melt bond at the interface between the barrier layer 104 and the panel composition 108, and/or a melt bond at interface of the barrier layer 104 and the fibers of the fibrous layer 102.

In another preferred embodiment of the invention, the surface of the barrier film 104 is heated at least to its melt temperature to result in a heat induced melt phase surface to melt bond with the fibers of the fibrous layer 102. The fibrous layer becomes melt bonded to the barrier film 104 when the melt phase surface is solidified by cooling below its melt temperature, which retains the fibrous layer 102 in place. The description herein refers to additional melt bonded structures, which are similarly fabricated.

A chemically induced melt phase refers to a thermoplastic composition in solid phase to which a compatible solvent is applied to produce a melt phase. In another preferred embodiment of the invention, the surface of the barrier film 104 is dissolved in a compatible solvent to produce a melt phase surface in the solvent. The fibrous layer 102 forms a chemically compatible bond with the melt phase surface. Alternatively, the solvent comprises an optional dissolved adhesive to increase the bond strength. The fibrous layer 102 becomes melt bonded to the barrier film 104 when the melt phase surface is solidified, by drying to drive off the solvent, which retains the fibrous layer 102 in place. The fabrication processes described herein apply similarly to the fabrication of other melt bonded structures to be described.

At least portions of fibers in the fibrous layer 102 are exposed from a side of the barrier layer 104 that faces away from the panel composition 108, and are free of contact with the panel composition 108 to be available for adhering another material to the panel 100. The fibrous layer 102 is permeable to another material intended to be assembled by adherence to the panel 100. Advantageously, the chemical composition of the fibrous layer 102 is selected for being chemically compatible with another material intended to adhere to the panel 100, to form a chemical bond therewith. Examples of such materials are disclosed herein.

Another embodiment of the composite 2 has two exemplary fibrous layers 102, 106 disposed against and melt bonded to opposite sides of the barrier layer 104 therebetween. FIG. 1A discloses a preferred embodiment of the invention wherein the fibrous layer 106 is melt bonded against a side of the barrier layer 104 that faces toward the panel composition 108. According to an embodiment of the composite 2, each of the fibrous layers 102, 106 comprises a mat of fibers covering the corresponding side of the barrier layer 104. The fibers of the fibrous layer 102 or 106 are nonwoven with a basis weight range of 10-200 gm/m² for example. The fibers extend lengthwise in a direction substantially along the major axis of the respective fibrous layers 102, 106. Further, the fibers are selected from the group consisting of, thermal bonded or chemically bonded carded web, thermally bonded or chemically bonded spun web, and wet laid. Further, the fibers of the fibrous layer 102 or 106 includes, but is not limited to, fiberglass or thermoset fibers, such as, polyester fibers, or a mixture of fiberglass or thermoset fibers and thermoplastic fibers, wherein the thermoplastic fibers is rendered to a heated melt phase state to enhance joining of the thermoset fibers against one side of the barrier layer 104 by melt bonding. For example, polyethylene terephthalate (PET) fibers mixed with polypropylene (PP) fibers, use melted PP fibers to bond with the PET fibers and compatibly bond with a thermoplastic or thermoset barrier layer 104, which joins the PP fibers and the PET fibers to one side of the barrier layer 104 and provide a fibrous layer 102 or 106.

According to an embodiment wherein the fibrous layer 106 is not present on an inner side of the barrier layer 104, the panel composition 108 forms a melt bond with the inner side of the barrier layer 104 that faces toward the panel composition 108. The barrier layer 104 partially imbeds in the surface of the panel composition 108 without being enveloped by the panel composition 108. However, when the fibrous layer 106 is present, as shown in FIGS. 1 and 1A, the fibrous layer 106 and the fibers thereof are substantially enveloped by the panel composition 108 except where the fibers melt bond with the barrier layer 104. According to an embodiment of the invention, the enveloped fibrous layer 106 reinforces the panel composition 108. Further, an embodiment of invention includes the melt bond being enhanced by internal pressure due to optional swelling of the fibrous composition of said one of the fibrous layers 106 while being enveloped by the panel composition 108 in a melt phase or melt state. Further, whether or not the fibrous layer 106 is present, the barrier layer 104 is impermeable to the melt phase, panel composition 108. Advantageously, the barrier layer 104, being impermeable, separates the panel composition 108 from the other fibrous layer 102, thereof such that the fibrous layer 102 is isolated or separated from the panel composition 108 to prevent contact therebetween. Further, the fibers in the fibrous layer 102 are exposed from the corresponding other side of the barrier layer 104 and are free of contact with the panel composition 108 to adhere other materials to the panel 100, to be described, hereinafter.

A preferred panel composition 108 comprises a polymeric resinous composition in a melt phase that envelops and melt bonds with the fibrous layer 106 when present, or that melt bonds with the barrier layer 104 when the fibrous layer 106 is absent. Desirably, a melt bond is formed at an interface of the chemically compatible barrier layer 104 and the fibrous layer 102. Further, a melt bond is formed at an interface of the chemically compatible barrier layer 104 and fibrous layer 106. According to the embodiment disclosed by FIG. 1A, the exemplary fibrous layer 102 is chemically compatible with the exemplary barrier layer 104 to form a melt bond therewith. The exemplary fibrous layer 106 is chemically compatible with the exemplary barrier layer 104 to form a melt bond therewith. The exemplary fibrous layer 106 is chemically compatible with the panel composition 108 to form a melt bond therewith. In an embodiment in which the exemplary fibrous layer 106 is absent, the exemplary barrier layer 104 is chemically compatible with the panel composition 108 to form a melt bond therewith.

The panel 100 is manufactured by applying the composite 2 against the panel composition 108 in a melt phase, one on the other, and horizontally or vertically against each other. In an alternative embodiment, the panel composition 108 comprises an applied coating that melt bonds with, and completely covers, said one of the fibrous layers 106, and has a thickness that extends beyond the thickness of the fibrous composition of said one of the fibrous layers 106. The panel composition 108 comprises, either a thermoset polymeric composition 108 including crystalline polymers in a prepolymerized melt phase, or a thermoplastic polymeric composition having at least its surface in melt phase, wherein the melt phase surface is heat induced or chemically induced by a solvent or by an adhesive at the interface with the composite 2. For example, a barrier layer 104 of higher melt temperature compared to the panel composition 108 is impermeable to the melt phase panel composition 108 that is heated to a melt phase. Pressure is applied to embed the fibrous layer 106 in the melt phase surface of the panel composition 108, and/or to partially embed the barrier layer 104 in the melt phase surface of the panel composition 108 when the fibrous layer 106 is absent. The panel composition 108 permeates and substantially envelopes the fibrous layer 106 when present. Further, said one of the fibrous layers 106 reinforces the panel composition 308. Further, the bond is enhanced by optional swelling of the fibrous composition of said one of the fibrous layers 106 within the panel composition 308. The barrier layer 104 is impermeable to the panel composition 108 and prevents contact between the panel composition 108 and the fibrous layer 102.

The thermoplastic polymeric panel composition 108 comprises substantially polypropylene, polyethylene, polyurethane, polystyrene, polyamide, polyester and copolymers thereof and amorphous crystalline polymers. Further additives include fibrous reinforcements, fillers and foam bubbles. The panel composition 108 comprises a solidifiable, melt phase resin of a thermoset or thermoplastic, consisting of, but not limited to, unsaturated polyester, epoxy or polyurethane. The liquid resin may contain reinforcement fibers, fillers and a foaming agent, such as air or chemical foaming agent. The resin wicks into one of the resin permeable fibrous layers 106 and permeates the same, as well as, permeates the scrim 310 when the scrim 310 is present. A thermosetting resinous composition 108 includes, but is not limited to, unsaturated polyester resins with or without styrene monomer as a reactive diluents, vinyl ester resins with or without reactive diluents, epoxy resins including catalyst and/or a complimentary reactive component or a Novolac® epoxy and high temperature epoxy and variants, phenolic resins including phenol-formaldehyde, urea formaldehyde resins, urethane resins, unsaturated acrylate resins, unsaturated methacrylate resins or siloxane resins. Examples of unsaturated polyesters include, but are not limited to, unsaturated orthophthalate polyester, unsaturated isophthalate polyester and unsaturated aliphatic polyester. Examples of urethane resins include, but are not limited to, aliphatic or aromatic isocyanate based (Component A) combined with polyester or polyether polypropyl based (component B), or isocyanurate type (high ratio of A:B).

A thermoplastic resinous composition 108 includes, but is not limited to, polyester resins, polypropylene resins, polyethylene reins, polyamide resins, polystyrene resins, acrylic resins, methacrylic resins, polyvinyl chloride resin, and copolymers thereof. Examples of polyesters include, but are not limited to, polyethylene terephthalate, polyethylene adiapate, polybutylene terephthalate, polycaprolactone, polylactic acid or polycarbonate. Examples of polypropylenes include, but are not limited to, isotactic polypropylene, syntactic polypropylene, amorphous polypropylene, ethylene propylene copolymer, acid modified polypropylene, or ethylene propylene diene monomer (EPDM). Examples of polyethylenes include, but are not limited to, linear low density polyethylene, high pressure low density polyethylene, medium density polyethylene, high density polyethylene and ethylene copolymers. Examples of ethylene copolymers include, but are not limited to, ethylene vinyl acetate (EVA) or ethylene acrylic acid (EEA). Examples of polyamides include, but are not limited to, Nylon 106™, Nylon 106, 106™, Nylon 106, 10™, Nylon 11™ and Nylon 12™. Examples of polystyrene include, but are not limited to: homopolymers, copolymers/terpolymers, such as, acrylonitrile-butadiene-styrene (ABS), or styrene-maleic anhydride (SMA).

Permeation of a corresponding fibrous layer 106 is readily accomplished by thermosetting polymers, which comprise low viscosity monomers or oligomers. Permeation of a corresponding fibrous layer 106 is readily accomplished by thermoplastic monomers of sufficient molecular weight to be liquids or solids at ambient temperature, such as, methyl methacrylate and caprolactone. High pressure molding may be used to promote permeation of a corresponding fibrous layers 106 by one of many thermoplastic polymers having relatively high viscosities while in the melt stage, such as, polyethylene and polypropylene. Alternatively, lower molecular weight (m.w.) surface regions, on volatile monomer based polymers having relatively high viscosity, can permeate a corresponding fibrous layer 102 or 106. For example, a surface layer of ethylene acrylic acid copolymer (EAA) of relatively low m.w. on a polyethylene layer can permeate the corresponding fibrous layer 102 or 106. Further, alternatively, fluorinated polymers comprise a thermoplastic, such as a fluoroethylene polymer (FEP) and non-thermoplastic polymers, such as, polytetrafluorethylene (PTFE). While PTFE is used, the PTFE is pulverized and dispersed in a fluid, and subsequently sintered to form a substantially continuous resinous panel composition 108.

According to one preferred embodiment, a panel 100 is fabricated with a thermoplastic panel composition 108, including, but not limited to, polypropylene, polyurethane, polystyrene, polyamide, polyester, polyolefin, such as, polyethylene (PE), polypropylene (PP), and copolymers thereof, polyvinyl chloride (PVC), polystyrene, and polyamide, such as, uncured nylon. Further, the composition 108 is air entrained or foamed. Further, the composition 108 is reinforced with fibers. Further the composition 108 is treated with one or more active reagents or non-reactive agents serving as, a filler, colorant, fire retardant, biocide, or fluid repellant.

According to an embodiment, the barrier layer 104 comprises an impermeable solid film. According to another embodiment, should the barrier layer 104 be rendered to a melt phase while being in contact with the melt phase panel composition 108, the barrier layer 104 has a high viscosity, i.e. a low melt index (MI) or low melt flow rate (MFR), which avoids permeation by wicking or otherwise flowing of the melt phase panel composition 108 through the barrier layer 104. Alternatively, the barrier layer 104 comprises a microporous film having pores that are too narrow to wick the melt phase panel composition 108. For example, the composition of the microporous barrier layer 104 includes, but is not limited to, PP film, sPP film, EPR film, or nonwoven PP/PET core/sheath. Accordingly, at least the side of the microporous barrier layer 104 on which the fibrous layer 102 is bonded is impermeable to the melt phase panel composition 108, which prevents engagement or contact between the panel composition 108 and the fibrous layer 102.

According to one preferred embodiment of a manufacturing method, the composite 2 is assembled onto a melt phase surface of the panel composition 108. The melt phase surface of the panel composition 108 is formed during manufacture of the panel 100 by spreading out a layer of the prepolymerized panel composition 108. Alternatively, the melt phase surface is formed by surface heating the panel 100 to its thermoplastic melt temperature, or by solvent chemical activation or adhesive chemical activation. Alternatively, the barrier layer 104 of the composite 2 is rendered at least partially to the melt phase state, for example, by surface heating to its thermoplastic melt temperature, or by solvent chemical activation or adhesive chemical activation. The composition 108 and the barrier layer 104 of the composite 2 are melt bonded to combine the two compositions by applying pressure while one or the other, or both, are in corresponding melt phase states. The composition of the barrier layer 104 and the composition of the panel composition 108 are chemically compatible to form a melt bond upon cooling to solidify the melt phase state compositions.

Upon solidifying the melt phase panel composition 108 while being bonded to one side of the barrier layer 104, for example, by appropriate cooling to ambient temperature, or by appropriate dissipation of the solvent or chemical activation composition, the two compositions become intimately bonded together, such that the composite 2 serves as a facing for the panel 100, and the fibrous layer 102 thereof, on another side of the barrier layer 104 is shielded by the barrier layer 104 from being permeated by the melt phase panel composition 108. Further, the fibrous layer 102 thereof, is free of the melt phase panel composition 108, and comprises an adhesion promoting, permeable fibrous layer 102 for adhering another material 700, FIGS. 7-9, to the panel 100. The panel composition 108 is then solidified from a melt phase to a solid phase by solvent drying, complete polymerization or cooling, as appropriate, to retain in place the composite 2. Embodiments of the composite 2 disclosed herein comprise layers 102, 104 and 106 that are chemically compatible to form melt bonds at their abutting interfaces. Further, the panel composition 108 is chemically compatible with the barrier layer 104 or the fibrous layer 106 when present to form melt bonds therewith. Further, the fibrous layer 102 has a fibrous layer composition selected for establishing a chemical bond with other materials 700 intended for adherence to the panel 100.

According to an embodiment of the invention in FIG. 1A, the panel composition 108 permeates said one of the fibrous layers 106, such that the thickness of the panel composition 108 is sufficient to permeate and fully encase or envelope the fibers of said one of the fibrous layers 106. As disclosed by FIG. 1B, the panel composition 108 extends beyond the projecting fibers 106a at the surface of said one of the fibrous layers 106. The panel composition 108 has a roughened, panel surface 107 covering the fibrous composition, due to the presence of the fibers of the fibrous layer 106 near the panel surface 107. For example, the roughened, panel surface 107 provides a non-skid surface, or a low gloss, matte finish surface, on the panel 100.

The embodiment of a composite 2 disclosed by FIG. 1A is exemplary of all embodiments of a composite 2, as disclosed herein. Similarly, the barrier layer 104 and the fibrous layer 102 disclosed by FIG. 1A are exemplary embodiments of a barrier layer and a fibrous layer in each of the embodiments of a composite 2, as disclosed herein. Similarly, the fibrous layer 106 disclosed by FIG. 1A is an exemplary embodiment of a fibrous layer in all embodiments of a composite 2, as disclosed herein, for bonding with a panel composition, as disclosed herein.

FIG. 2 discloses another embodiment of a panel 200 fabricated with a flexible or rigid composite 2 that provides a facing for the panel 200. The composite 2 has at least two penneable fibrous layers 202, 206 bonded to, and against opposite sides of a barrier layer 204 therebetween. Further the panel 200 comprises, a resinous panel composition 208 bonded to said one of the fibrous layers 206 of the composite 2. Various embodiments of the fibrous layers 202, 206, barrier layer 204 and resinous panel composition 208 are similar to the corresponding, various embodiments of the fibrous layers 102, 106, barrier layer 104 and resinous panel composition 108. In addition, the panel composition 208, in FIG. 2, is thicker, compared to the composition 108 disclosed by FIG. 1A, so as to extend substantially beyond said one of the fibrous layers 206. The thicker panel composition 208, when solidified, forms a panel surface 207 that covers and extends beyond said one of the fibrous layers 206. The panel surface 207 on the panel composition 208 is formed with a desired surface finish or surface texture.

Advantageously, the barrier layer 204 separates the panel composition 208 from the other fibrous layer 202 thereof, that is against another side of the barrier layer 204, such that the fibrous layer 202 thereof, is isolated from contact with the panel composition 208. Further, portions of the fibers in the fibrous layer 202 are exposed from the other side of the barrier layer 204 and are free of the panel composition 208 to adhere another material 700.

Another embodiment of the invention is obtained by the composite 2 having the fibrous layer 202 and the barrier layer 204, without the fibrous layer 206. The composite 2 serves as a panel facing, by imbedding the barrier layer 204 at least partially in the surface of the melt phase panel composition 208. Further, the partially imbedded barrier layer 202 and the panel composition 208 are melt bonded.

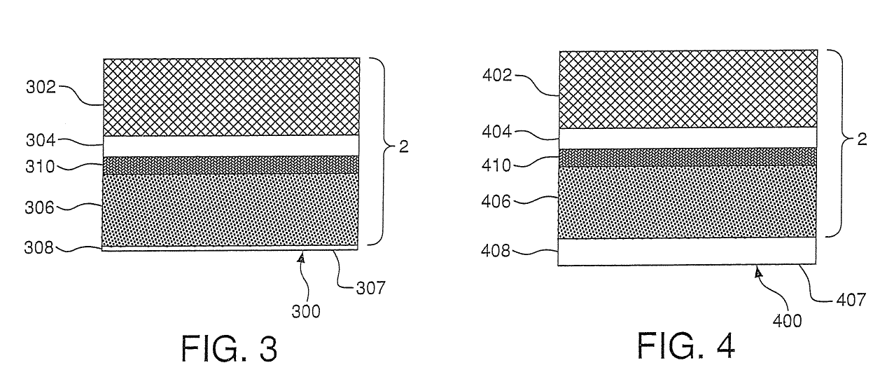

FIG. 3 discloses another embodiment of a panel 300 fabricated with a flexible or rigid composite 2 having at least two permeable fibrous layers 302, 306 against, and melt bonded to, a barrier layer 304 therebetween. Further, the composite 2 has a scrim 310 against the barrier layer 104. The scrim 310 prevents shrinking or warping of the fibrous layers 302, 306 as they undergo strain under the stresses applied by manufacturing operations. The scrim 310 is an open mesh, having woven or nonwoven yarns melt bonded to one side of the barrier layer 304.

One of the fibrous layers 306 extends into openings between spaced apart yarns of the scrim 310, and is melt bonded to and against the barrier layer 304. The fibrous layer 306 bonds the scrim 310 to the barrier layer 304. Alternatively, the scrim 310 itself is melt bonded to the barrier layer 304. Further, said one of the fibrous layers 306 of the composite 2 is melt bonded to a resinous panel composition 308. Preferably, the panel composition 308 permeates said one the permeable fibrous layers 306 and the scrim 310, to fully encase and envelope the fibrous layer 306 and the scrim 310. Alternatively, the scrim 310 is melt bonded to the other side of the barrier layer 304 from the panel composition 308, such that, the fibrous layer 302 extends into the openings of the scrim 310, and is melt bonded to and against the barrier layer 304.

According to an embodiment disclosed by FIG. 3, the thiclness of the panel composition 308 fully encases or envelopes the fibrous layer 306, similar to the previously described panel composition 108 that encases and envelopes the fibrous layer 106, according to FIG. 1B. When the scrim 310 is present, the thickness of the panel composition 308 is increased sufficiently to permeate, and fully encase and envelope, the scrim 310 and said one of the fibrous layers 306. The panel composition 308 has a roughened panel surface 307 covering the fibrous composition near the surface 307 of the panel composition 308, similar to the previously described, roughened surface 107 as disclosed by FIG. 1B.

Advantageously, the barrier layer 304 separates the panel composition 308 from the other fibrous layer 302 thereof, against another side of the barrier layer 304, such that the fibrous layer 302 thereof, is isolated from contact with the panel composition 308. Further, at least portions of the fibers in the fibrous layer 302 are exposed from the other side of the barrier layer 304 and are free of the panel composition 308 to adhere another material 700.

Another embodiment of the invention is obtained by the composite 2 having the fibrous layer 302 and the barrier layer 304, without the fibrous layer 306. The composite 2 serves as a panel facing, by imbedding the barrier layer 304 at least partially in the melt phase panel composition 308, and the panel composition 308 melt bonds to the partially imbedded barrier layer 302. At least a portion of the fibrous layer 302 is exposed from the barrier layer 304 to assist in adherence of another material 700.

FIG. 4 discloses another embodiment of a panel 400 fabricated with a flexible composite 2 having at least two permeable fibrous layers 402, 406 against, and bonded to, a barrier layer 404 therebetween. Further, the composite 2 has a scrim 410 against the barrier layer 404. The fibrous layer 406 bonds the scrim 410 to the barrier layer 404. Further the panel 100 comprises, a resinous panel composition 408 bonded to, and fully encapsulating, said one of the fibrous layers 406 of the composite 2. Preferably, the panel composition 408 permeates said one the permeable fibrous layers 406 and the scrim 410, fully encasing and encapsulating the fibrous layer 406 and the scrim 410. One of the fibrous layers 406 extends into openings between spaced apart yarns of the scrim 410, and is melt bonded to and against the barrier layer 404. The fibrous layer 406 bonds the scrim 410 to the barrier layer 404. Alternatively, the scrim 410 itself is melt bonded to the barrier layer 404. Further, said one of the fibrous layers 406 of the composite 2 is melt bonded to a resinous panel composition 408. Preferably, the panel composition 408 permeates said one the permeable fibrous layers 406 and the scrim 410, to fully encase and envelope the fibrous layer 406 and the scrim 410. Alternatively, the scrim 410 is melt bonded to the other side of the barrier layer 404 from the panel composition 408, such that, the fibrous layer 402 extends into the openings of the scrim 410, and is melt bonded to and against the barrier layer 404.

Another embodiment of the invention is obtained by the composite 2 having the fibrous layer 402 and the barrier layer 404, without the fibrous layer 406. The fibrous layer 402 bonds the scrim 410 to the barrier layer 404. The composite 2 serves as a panel facing, by imbedding the barrier layer 404 at least partially in the melt phase panel composition 408, and the panel composition 408 melt bonds to the partially imbedded barrier layer 402. At least a portion of the fibrous layer 402 is exposed from the barrier layer 404 and is free of the panel composition 408 to adhere another material 700.

Various embodiments of the fibrous layers 402, 406, barrier layer 404, scrim 410 and resinous panel composition 408 are similar to the various embodiments of the fibrous layers 302, 306, barrier layer 304, scrim 310 and resinous panel composition 308. hI addition, the panel composition 408 is substantially thicker than the resinous panel composition 308. The thicker panel composition 408, when solidified, forms a panel surface 407 that extends beyond the thiclness of the fibrous composition of said one of the fibrous layers 406. The panel surface 407 on the panel composition 408, is formed with a desired surface finish or surface texture, to be described hereinafter.

FIGS. 3 and 4 disclose the scrim 310 and 410, respectively, melt bonded to said one side of the barrier layer 304, 404, respectively. Alternatively, the scrim 310, 410 is melt bonded to the other side of the barrier layer 304, 404 from the panel composition 308, 408. Further, one side or both sides of the barrier layer 304, 404 can have respective scrims 310, 410 bonded thereto.

According to an embodiment of the invention, the composite 2 comprises a barrier layer 104 and a fibrous layer 102 applied one on the other, wherein the fibrous layer 102 comprises glass fibers or fiberglass. According to another embodiment each of the fibrous layers 102, 106 comprises glass fibers or fiberglass applied one on the other with the barrier layer 104. The fiberglass of the fibrous layer 102 melt bonds to a melt phase polymeric barrier layer 104, and farther establishes a bond with a melt phase material 700 intended for adherence to an exemplary panel 100. Each of the barrier layer 104 and the material 700 comprises a wide variety of thermoplastic or thermoset, melt phase polymeric compositions. The composition of the barrier layer 104 is selected to be chemically compatible to form a melt bond with the melt phase composition 108 of the panel 100. The surface chemistry of fiberglass is of low phobicity to the adherent macromolecular morphology formed by a melt phase surface of the polymeric compositions. The fiberglass fibrous layer 102, 106 has a higher melt temperature than the polymeric compositions, and is insoluble in solvents of such polymeric compositions, while being chemically compatible to melt bond with the melt phase of the polymeric compositions.

According to another embodiment of the invention, the composite 2 comprises a barrier layer 104 and a fibrous layer 102 applied one on the other, wherein the fibrous layer 102 comprises a polymeric material having a higher melt temperature than a polymeric material of the barrier layer 104. The surface of the barrier layer 104 is heated to form a melt phase surface that is chemically compatible with the fibrous layer 102 to melt bond therewith. For example, a fibrous layer 102 of unsaturated polyester composition forms a melt bond with a melt phase surface of a barrier layer 104 of polypropylene.

Another embodiment of a composite 2 is manufactured, for example, by extruding a polyurethane barrier layer 104. The barrier layer 104 is chemically compatible with fibrous layers 102 and 106, one of which comprises polyester fibers, and the other of which comprises polypropylene fibers melt bonded to the barrier layer 104. The barrier layer 104 of polyurethane has a higher melt temperature that either of polyester or polypropylene. The surface of the barrier layer 104 is heated at least to the melt temperature of polyester to form a melt bond with the polyester fibers. Afterward, the other surface of the barrier layer 104 is heated at least to the melt temperature of polypropylene to form melt bonds with the polypropylene fibers. Accordingly, a the fibrous layer 102 or 106 that has a higher melt temperature of polyester, for example, is heated and melt bonded to a corresponding side of the barrier layer 104, to form a previously bonded layer, followed by heating and melt bonding the fibrous layer 102 or 106 at a lower melt temperature of polypropylene, for example, to an opposite corresponding side of the barrier layer 104 to form a subsequently bonded layer.

According to another embodiment of the invention, a bicomponent, exemplary barrier layer 104 is fabricated by a coextrusion process comprising, extruding a melt phase thennoplastic or thermoset having a higher melt temperature, for example, polyurethane, to form a first side of the barrier layer 104, while extruding a melt phase thermoplastic of lower met temperature, for example, a polyolefin, such as, polypropylene, to form a second side of the barrier layer 104, which sides are melt bonded by the coextrusion process, and which become melt bonded together to form a composite barrier layer 104 comprised of two layers.

According to an embodiment of the invention the composite 2 has a fibrous layer 102 comprised of polyester fibers. The polyester fibers are melt bonded to the polyurethane side of the barrier layer 104. For example, the surface of the polyurethane side is heated to form a melt surface, without melting the entire thickness of the polyurethane side. The polyester fibers are deposited on the melt surface of the polyurethane side to melt bond therewith. According to an embodiment of the invention, the polyester fibers serve as the fibrous layer 102 when the polypropylene side of the barrier layer 104 is selected to melt bond directly to a melt phase panel composition 108 of an exemplary panel 100.

Embodiments of the polyurethane composition include, a polymer produced by a reaction of polyisocyanates with polyester-based or polyether-based resins, to produce either a thermoplastic or a thermosetting polyurethane composition. A thermoplastic polyurethane composition is preferred. Embodiments of polyolefin compositions include, but are not limited to; polymers and copolymers of, polypropylene, polyethylene, ethylene-vinyl acetate ionomer, polybutylene, and polymethylpentene. The polyurethane composition is chemically compatible with polyester to form a melt bond therewith. The melt bond can form at the melt temperature of a polyolefin, for example, polypropylene, and below the higher melt temperature of the polyurethane composition. The polyurethane material has a higher melt temperature than the unsaturated polyester composition. The surface of the polyurethane film is heated at least to the melt temperature of the polyester fibers of the fibrous layer 102 or 106 to the melt temperature of the polyester fibers to melt bond the fibers to the polyurethane film surface. Advantageously, the polyurethane composition of higher melt temperature than the fibers to remain as an impermeable barrier layer 104 without forming voids through the thickness of the barrier layer 104. The polyurethane composition, whether thermosetting or thermoplastic, is chemically compatible with the melt phase polyester composition to form a melt bond therewith. According to an alternative embodiment, when the polyurethane is a thermoplastic, the surface of the polyurethane is heated to a tacky viscosity to further enhance fusing to the fibers, without forming voids through the thickness of the polyurethane film layer.

According to another embodiment of the invention, the fibrous layer 102 comprises polypropylene fibers melt bonded to a polypropylene side of the barrier layer 104. The surface of the polypropylene side of the barrier layer 104 is heated at least to its melt temperature to form a melt surface, without melting the entire thickness of the polypropylene side. The polyurethane side of the barrier layer 104 has a higher melt temperature and does not melt while melt bonding the polypropylene fibers to the polypropylene side of the barrier layer 104. According to an embodiment of the invention, the polypropylene fibers serve as the fibrous layer 102 when the polyurethane side of the barrier layer 104 is selected to melt bond directly to a melt phase panel composition 108 of an exemplary panel 100.

According to an embodiment of the invention the composite 2 has one of the fibrous layers 102 or 106 comprised of polyester fibers and the other of the fibrous layers 102 or 106 comprised of polypropylene fibers.

After the polyester fibers of one of the fibrous layers 102 or 106 have been melt bonded to the polyurethane side of the barrier layer 104, the surface of the polypropylene side of the barrier layer 104 is heated at least to the melt temperature of polypropylene to form a melt surface. The polypropylene fibers of the other of the fibrous layers 102 or 104 are deposited on the melt surface to melt bond therewith. The polyurethane side of the barrier film 104, as well as, the polyester fibers have a higher melt temperature than that of the polypropylene side of the barrier layer 104 and do not melt when melt bonding the polypropylene fibers. 106.

Advantageously, the fibrous layers 102 and 106 on the same composite 2 are of different chemical families, such that they are interchangeable one with the other to attain chemical compatibility with a panel composition 108 and chemical compatibility with another material 700. Thus, the composite 2 solves a problem wherein the panel composition 108 is difficult to bond with another material 700 of a different chemical family.

When an embodiment having a scrim 310 is desired, the scrim 310 is fabricated as an open mesh having woven or nonwoven strands. The scrim 310 is added, preferably against the polypropylene layer of the barrier layer 104, such that the polypropylene layer melts and fuses to the scrim 310. Further, the polypropylene fibrous composition covers the scrim 310, and further, extends through openings in the scrim 310 to register against the polypropylene layer of the barrier layer 104. The polypropylene fibrous composition melts and fuses to the polypropylene film of the barrier layer 104, and to the scrim 310, as well. The scrim 310 has a melt temperature higher than that of polypropylene. In other embodiments, for example, the scrim 310 comprises polyester strands or fiberglass strands, which are of higher melt temperature and higher tensile strength or elastic modulus than polypropylene. For example, a scrim 310 in each embodiment hereof, is fabricated as an open mesh of strands of polyester or fiberglass, that is woven, nonwoven, or knit, with a binder of a thermoplastic or thermoset resinous coating serving to adhere the strands together and/or to adhere the scrim 310 against one side of the barrier layer 104. The scrim composition is selected to be chemically compatible with the composition of the barrier layer 104 to form a melt bond therewith, and/or with the corresponding fibrous layer 102 or 104 to form a melt bond therewith.

Alternatively, the scrim 310 is fabricated as an open mesh having woven or nonwoven fiberglass strands. The fiberglass has a higher melt temperature than that of the polyester fibrous composition, which permits the scrim 310 to be added, preferably against the polyurethane layer of the barrier layer 104, such that the polyester fibrous composition covers the scrim 310, and further, extends through openings in the scrim 310 to register against the polyurethane layer of the barrier layer 104. The polyurethane layer of the barrier layer 104 and the scrim 310 thereon are heated at least to the melt temperature of the polyester fibers to melt bond the scrim 310 and the barrier layer 104 to respective polyester fibers.

Another embodiment of a bicomponent barrier layer 104 is fabricated by coextrusion of a melt phase polyurethane composition to form a first film layer and a melt phase polyethylene composition to form a second film layer, which film layers are fused together when in melt phase during the coextrusion process, and then solidified by being cooled, to form a composite barrier layer 104 comprised of the two film layers. The polyethylene layer of the barrier layer 104 is substituted for the polypropylene layer in the previously described embodiments of the invention. Further, a fibrous layer 102 or 106 comprised of polyethylene fibers are substituted for the polypropylene fibers in the previously described embodiments of the invention. Except for altering melt temperatures due to substitution of polyethylene for polypropylene, the process of manufacture to form melt bonds is the same by comparison with the previously described embodiments.

Preferably, each of the fibrous layers 102 and 106 is chemically compatible with another material 700 and with the thermoplastic composition 108, respectively, to form a chemical bond, including a melt bond, therewith. For example, the unsaturated polyester fibers are chemically compatible with a polymeric resin including, but not limited to; polyester, polystyrene and polyurethane to form a chemical bond, including a melt bond, therewith. The polypropylene fibers are chemically compatible with a polymeric resin including, but not limited to; polyolefins and polyurethanes to form a chemical bond, including a melt bond, therewith. The polyethylene fibers are chemically compatible with a polymeric resin including, but not limited to, polyolefins to form a chemical bond, including a melt bond, therewith.

The preferred fibers of the fibrous layers 102, 106 are polyester, polypropylene, polyvinyl chloride or fiberglass, which are chemically compatible with polar (resin swellable) liquid resins comprising, polyester, vinyl ester, styrene, propylene, epoxy and urethane to form a chemical bond, including a melt bond, therewith. Alternatively, polyethylene fibers are chemically compatible with polyethylene liquid resin to form a chemical bond, including a melt bond, therewith.

In various embodiments of the invention, the fibrous layer 102, 104 has a thiclness in the range of 0.003 inch to 0.100 inch (0.0762 mm. to 2.54 mm.). The thickness of each of the fibrous layers 102, 106 is variable for flexibility and size considerations. For example, the thickness comprises a thin, film or veil or tissue. Preferably, a lightweight, flexible composite 2 comprising the barrier layer 104 and the fibrous layers 102, 106 has a basis weight of about 100 g/m², and flexible, analogous to a permeable, tissue paper or tissue film. Further, for example, the thickness comprises a permeable mat of greater thickness than a thin, film or veil or tissue. Each of the fibrous layers 102, 106 has a basis weight range, 10-200 g/m², for example.

Each layer in the bicomponent barrier layer 104 has a single layer thickness in the range of 0.002 inch to 0.005 inch (0.0508 mm. to 0.013 mm.). The scrim 310, when present has a thickness in the range of 0.004 inch to 0.012 inch (0.0102 mm. to 0.0305 mm.). Preferably each of the fibrous layer 102, 106 comprises unwoven fibers, for example, a thermal-bonded carded web, thermal-bonded spun web, chemically-bonded carded web, wet-laid, loose fibers, or a combination thereof. Further, the relative thickness and relative strength, flexibility or stiffniess of the panel 100 depends upon the physical and chemical characteristics of the panel composition 108, and of the other compositions, which are selected for making the composite 2 prior to assembling the composite 2 on the panel 100. Further, each layer of the panel 100 and composite 2 is selected to have a composition selection and thickness, which imparts desired mechanical and chemical properties, for example, thinness or thickness, strength or weakness, flexibility or rigidity, resistance to impact or puncture or tear, surface finish, fire resistance, rain and water resistance, ultraviolet radiation resistance, biological fluids resistance and stain resistance.

To manufacture planar flat, panels 100, 200, 300, 400 having the cross sections as disclosed by FIGS. 1-4, a melt phase polymeric resinous panel composition 108, 208, 308 or 408 is intended to form a corresponding planar flat, panel with the composite 2. The panel composition and the composite are applied one on the other. For example, the panel composition 108, 208, 308 or 408 in a melt phase is spread onto a flat planar forming surface, not shown, on a stationary table or on a moving, continuous conveyor of a known manufacturing apparatus. The corresponding flexible or rigid composite 2 is laid onto the melt phase panel composition 108, 208, 308 or 408. Alternatively, the corresponding flexible composite 2 is spread onto a flat planar forming surface, and the melt phase panel composition 108, 208, 308 or 408 is applied onto the composite 2. Pressure is applied, for example, against the composite 2 to urge the composite 2 and the melt phase polymeric resinous composition 108, 208, 308 or 408, one into the other, causing said composition 108, 208, 308 or 408 to permeate the corresponding fibrous layer 106, 206, 306 or 406, and to permeate the scrim 310 or 410, when the scrim 310 or 410 is present. The corresponding barrier layer 104, 204, 304 or 404 is impermeable to the panel composition 108, 208, 308 or 408 and isolates the corresponding fibrous layer 102, 202, 302 or 402 from contact by the panel composition. In embodiments wherein the corresponding fibrous layer 106, 206, 306 or 406 is not present, the corresponding barrier layer 104, 204, 304 or 404 imbeds at least partially in the melt phase polymeric resinous composition 108, 208, 308 or 408 and a melt bond is formed therebetween.

When the resinous composition 108, 208, 308 or 408 of the corresponding panel comprises a thermoplastic, the resinous composition 108, 208, 308 or 408 is rendered to a melt phase, as described herein, for melt bonding the corresponding solid phase barrier layer 104, 204, 304 or 404 thereto. Alternatively, the surface of the thermoplastic resinous composition 108, 208, 308 or 408 of the corresponding panel is rendered at least partially to a melt phase state, as described herein, which produces a melt phase surface of the panel composition 108. Alternatively, when the resinous composition 108, 208, 308 or 408 of the corresponding panel comprises a thermosetting resinous composition, i.e., a thermoset, the corresponding barrier layer 104, 204, 304 or 404 melt bonds while said thermosetting resinous composition 108, 208, 308 or 408 is in a prepolymerized melt phase. Alternatively, the inner surface of the corresponding barrier layer 104, 204, 304 or 404 is rendered to a melt phase limited to its inner surface by applying surface heat or by applying a thin coating of solvent, which forms a melt phase surface to melt bond with the resinous composition 108, 208, 308 or 408.

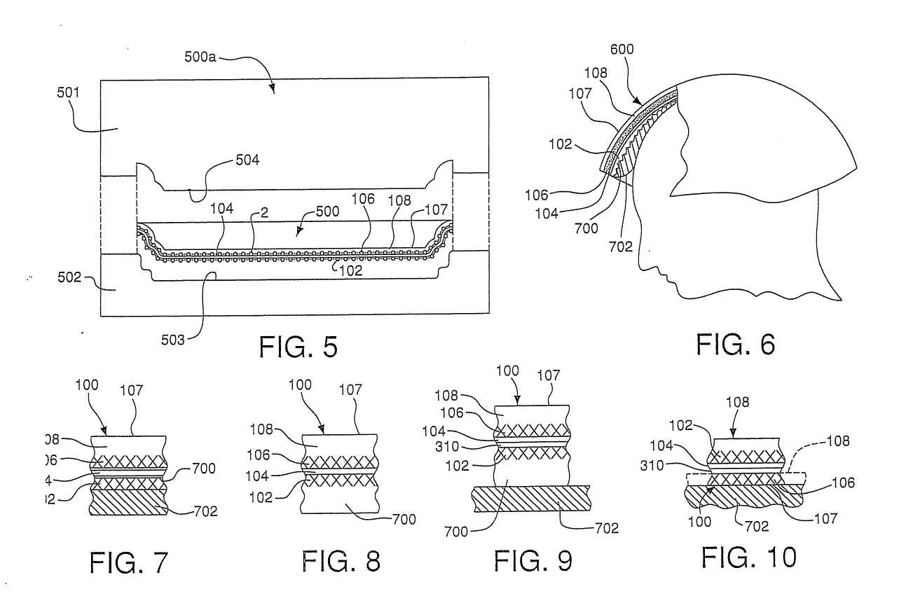

FIG. 5 discloses an embodiment of a method and apparatus for shaping a curvilinear panel 500 and composite 2. Although FIG. 5 discloses the flexible composite 2 as comprising the embodiment of FIG. 1A, alternatively, the flexible composite 2 comprises one of the embodiments of FIGS. 1A, 2, 3 or 4. The panel 500 and composite 2 are shaped, for example, by molding in a molding apparatus 500a. The molding apparatus 500a has a pair of molding dies 501, 502 that close toward each other to define a closed mold cavity 503 therebetween. Although the mold cavity 503 is disclosed by FIG. 5 as comprising a curvilinear shape, the mold cavity shape comprises alternative embodiments, for example, a flat planar shape that will form a corresponding flat planar panel 100, 200, 300 400.

The flexible composite 2 for making the panel 500 is placed in the open mold cavity 503, with the dies 501, 502 apart from each other. Then the dies 501, 502 are closed. A quantity of a corresponding, permeating resinous panel composition 108, alternatively, 208, 308 or 408, in a melt phase state is injected into the closed mold cavity 503 to fill the mold cavity 503, and to permeate a corresponding one of the permeable fibrous layers 106, alternatively, 206, 306 or 406. Alternatively, the resinous composition 108 is pooled and spread in the mold cavity 503 before the mold dies 501, 502 are closed and heat is applied to melt the panel composition 108.

While the dies 501, 502 are closed, the corresponding resinous composition 108, and the composite 2, are shaped by a corresponding interior shape of the mold cavity 503. The resinous composition 108 flows under the application of pressure applied by the mold cavity 503, to fill the mold cavity 503 and bond to the composite 2. Heat and pressure are applied to promote a low viscosity flow of the melt phase resinous composition 108. After cooling the resinous composition 108 to form a solidified state, the mold cavity 503 is opened, and the shaped panel 100 and composite 2 are removed. The panel 100 and composite 2 are shaped with one or more, generally curvilinear sections, which conform to the shape of a forming surface 504 of the mold 500a.

With continued reference to FIG. 5, the corresponding resinous composition 108 has a corresponding panel surface 107 that is formed against a corresponding forming surface 504 on the mold cavity 503. The surface texture or smoothness of the forming surface 504 transfers to the panel surface 107. Alternatively, when the resinous composition 108 has a thickness as disclosed by FIG. 1B, then the resinous composition 108 will have a corresponding rough surface 107, due to the presence of the fibrous composition of the fibrous layer 106 near the corresponding surface 107.

In FIG. 5, the panel 100 and composite 2 are concave in shape, at least in part. The concave shape is formed against a corresponding forming surface 504 at one side of the mold cavity 503. Alternatively, the forming surface 504 is concave, instead of convex. A forming surface 504 that is concave can form a convex panel 100 and composite 2, for example, a convex panel 600 and composite 2, as disclosed in FIG. 6.

FIG. 6 discloses an embodiment of a curvilinear, convex panel 600 comprising, for example, a cycler's helmet. The helmet has a panel 600 that is convex in shape, at least in part, in the form of a shell, for example. The convex shape is formed against a corresponding, forming surface 504 of the mold 500a that is concave, instead of being convex as shown in FIG. 5. The panel 600 in the mold cavity 503 must be oriented, such that the panel composition 108 of the panel 600 is against the desired forming surface 504. Alternatively, a curvilinear panel can have both concave and convex portions, by making the forming surface 504 of the mold 500a both, convex in part, and concave in part.

In each of the embodiments disclosed by FIGS. 1-6, preferably, the corresponding fibrous layer 106 is enveloped by a corresponding melt phase, polymeric resinous composition 108. Further, the corresponding barrier layer 104 is impermeable to the corresponding resinous composition 108. The resinous composition 108 is against one side of the barrier layer 104. Advantageously, the corresponding barrier layer 104 separates the resinous composition 108 from a fibrous layer 102 that is against another side of the barrier layer 104, such that, the fibrous layer 102 is isolated from the resinous panel composition 108. As disclosed by FIG. 6, at least a portion of the fibers in the fibrous layer 102 are at least partially exposed from the barrier layer 104 to adhere another material 700, to be described.

In each of the embodiments disclosed by FIGS. 1-6, the barrier layer 104, 204, 304 or 404 forms an inner boundary of the resinous panel composition 108, 208, 308 or 408, which controls the thickness. More specifically, the panel composition 108, 208, 308 or 408 is applied in a controlled thickness to encase or envelope the fibers of the fibrous layer 106. For example, a thin, lightweight panel 600 is desired for a cycler's hehnet, as disclosed by FIG. 6. The panel 600 has a panel surface 107 that is smooth, aerodynamic in shape, and resistant to rain, impact and ultraviolet radiation. The absence of a scrim 310 or 410 complements the thinness of the panel 600.

The panel composition 108, 208, 308 or 408 is applied in a controlled thickness to encase or envelope the fibrous layer 102, 202, 302 or 402 and the scrim 310 or 410, when the scrim 310 or 410 is present, as disclosed in FIGS. 3 and 4. Alternatively, the panel composition 108, 208, 308 or 408 is applied in a controlled thickness to have a thickness substantially greater than that of the fibrous layer 106, 206, 306 or 406, as disclosed in FIGS. 2, 4, 8 and 9.

In FIGS. 1-6, individual fibrous layers 102, 106, 202, 206, 302, 306, 402 or 406 are thin to comprise a thin veil or tissue, in which lengths of individual fibers are nonwoven and lay substantially elongated within and along the thickness plane of the veil or tissue. In an alternative embodiment, the individual fibers are larger in diameter, or larger in cross section, to form a correspondingly thicker fibrous layer. In another alternative embodiment, the individual fibers are overlapped or stacked, one on another, or are interwoven to build up the number of fibers that cumulatively contribute to the thickness. In another alternative embodiment the ends of the individual fibers project or point themselves in outward directions to provide a raised nap that increases the thickness.

For example, each of the two permeable fibrous layers 102, 106, 202, 206, 302, 306, 402 or 406 of fibrous composition is preferably 3-20 thousandths inch thick. The barrier layer 104 is preferably 1-5 thousandths inch thick. The scrim 310 or 410 is preferably 4-12 thousandths inch thick. Thus, by selecting a relatively thin barrier layer 104, 204, 304 or 404 and two relatively thin permeable fibrous layers 102, 106, 202, 206, 302, 306, 402 or 406, a relatively thin panel 100 is fabricated. The embodiments according to FIG. 3 or FIG. 4 may be fabricated when additional reinforcement is provided by having the scrim 310, 410 present in the corresponding fibrous layer, for embedding in the corresponding panel composition 308, 408.

According to each of FIGS. 1, 5 and 6, the flexible composite 2 is formed by at least two flexible, fibrous layers 102, 106 bonded to opposite sides of a flexible, barrier layer 104. According to embodiments disclosed by FIGS. 3 and 4, the corresponding flexible scrim 310 or 410 is bonded to a side of a corresponding barrier layer 304 or 404. The composite 2 is bendable or flexible to follow the course of an exemplary bent or curvilinear path, embodiments of which are disclosed in FIGS. 5 and 6.

Each of FIGS. 7, 8, 9 and 10 discloses a corresponding embodiment of the invention, in which the fibrous layer 102 thereof, is isolated by the barrier layer 104 to be free of the permeating panel composition 108. At least portions of the fibers in the fibrous layer 102 thereof, are at least partially exposed from the barrier layer 104 to adhere another material 700. Further, adherence is enhanced by optional swelling of the fibrous layer 102 thereof, within said another material 700.

In the embodiment disclosed by FIG. 7, the fibrous layer 102 of the panel 100 is permeated by said another material 700 comprising an adhesive to adhere a tangible object 702 including, but not limited to, a layer of soft material for a cushion or pad to line the cycler's helmet 600 disclosed in FIG. 6. Further, alternatively, the panel 100 comprises a shell for a contoured chair or other seating formed, for example, by a molding process according to FIG. 5. The tangible object 702 for the chair or other seating comprises a cushion for the chair or other seating instead of for a helmet 600. In another embodiment disclosed by FIG. 7, for example, said another material 700 comprises an adhesive adhering to a tangible object 702 comprising another panel in the form of a stationary wall, a partition, flooring, a ceiling, a shaped vessel hull or a shaped wall of a container, such as, a refrigerator. Alternatively, the panel 100 comprises a liner for lining a tangible object 702 including, but not limited to, a bathtub or a shower stall. Further, alternatively, the panel 100 comprises part of a shaped panel 702 formed into a contoured chair or other seating. For example, said another material 700 is formed in situ in a melted, melt phase or fluent state, to permeate the fibrous layer 102 thereof.

Further, for example, the other material 700 includes, but is not limited to, a polymeric resin composition of polyurethane, polystyrene or polyamide, with a foaming agent that permeates the fibrous layer 102 thereof. An embodiment of said other material 700 of sufficient thickness comprises a thickened cushion or padding, for example, which is ideal for cushioning a cycler's helmet 600, as disclosed by FIG. 6, or for cushioning a chair or other seating. Alternatively, the other material 700 comprises, a thermally insulated, or sound insulated, exterior panel 100 for covering said tangible object 702, wherein said tangible object 702 comprises a wall, a partition, a ceiling or a floor. Further, an alternative embodiment of the panel 100 is insulated by the other material 700 to comprise an insulated interior panel 100 for lining the interior of a large or small container or vessel, including, but not limited to, the interior of a refrigerator or the interior of a thermally insulated or sound insulated carrel or stall.

Advantageously, the panel 100 is assembled with the composite 2, such that the panel 100 is provided with the fibrous layer 102 to adhere another material 700. Further, such material 700 includes, but is not limited to, a thermoset or thermoplastic resinous composition or other organic composition. Examples include, but are not limited to, unsaturated polyester, vinyl ester, epoxy, Novolac epoxy and high temperature epoxy and variants, urea formaldehyde, phenol formaldehyde, orthophthalate polyester, isophthalate polyester, acrylic, and methacrylic. Further variants of the material 700 comprise air entrained or foamed compositions, compositions reinforced with fibers, compositions treated with one or more active reagents or non-reactive agents serving as, a filler, colorant, fire retardant, biocide, or fluid repellant.

According to further embodiments of the invention, as disclosed by FIG. 9, said another material 700 comprises a thermal insulation, a sound absorbent composition, a cushion, padding or a filler, which is formed in situ to permeate the fibrous layer 102 thereof, that is isolated by the barrier layer 104 to be free of the panel composition 108.

Further, with reference to FIG. 8, in an alternative embodiment, the panel 100 is reinforced by adding the scrim 310 to the composite 2.

FIG. 9 discloses an embodiment of the panel 100, which is similar to the embodiment disclosed by FIG. 8. Further, FIG. 9 discloses an embodiment of a panel 100, wherein the other material 700 is formed in situ between the fibrous layer 102 and a tangible object 702 comprising a fixed wall or another panel, which can comprise, for example, an interior or exterior building wall or panel, a partition wall, a container wall or a vessel wall, including, but not limited to, the wall of a refrigerator or the wall of a thermally insulated or sound insulated carrel or stall. The other material 700 adheres to the wall or panel 702, as well as, melt bonds to the barrier layer 104 and the fibrous layer 102 thereof. Further, FIG. 9 discloses the other material 700 permeating a reinforcement scrim 310 that is added to the composite 2, and which reinforces the other material 700. According to an embodiment, the reinforcement scrim 310 is absent from the composite 2. According to another embodiment, a reinforcement scrim 310 or 410 is present, as disclosed by FIGS. 3 and 4.

FIG. 10 discloses an embodiment of the panel 100 that is similar to the embodiment disclosed by FIG. 102. Further, FIG. 10 discloses, an adhesive panel composition 108 on a surface of, a wall, ceiling, floor or roadway, followed by applying the fibrous layer 106 of the panel 100 onto the adhesive panel composition 108, causing the panel composition 108 to permeate the fibrous layer 106. The fibrous composition of the fibrous layer 106 provides a non-skid surface 107 against the corresponding wall, ceiling, floor or roadway. Further, FIG. 10 discloses the other fibrous layer 102 thereof, that is free of the permeating composition of the panel composition 108, for attaching to further compositions that would cover and permeate the fibrous layer 102 thereof to form a panel 104, wherein the panel 104 includes, but is not limited to; wall paneling, cementitious paneling, ceiling paneling, flooring or a panel of bituminous road surfacing composition.

Additional compositions for manufacturing each fibrous layer 102, the barrier layer 104 and the scrim 310 are disclosed in U.S. Ser. No. 10/843,257, filed May 11, 2004, published application US 2004/0214489 A1, and in U.S. Ser. No. 10/731,767, filed Dec. 9, 2003, published application US 2005/0124240.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention. Pending patent applications and publications referred to hereinabove are expressly incorporated herein by reference.

What is claimed is:

1. A panel comprising:
a polymeric panel composition comprising a panel substrate;
a composite bonded to the panel composition to provide a panel facing on the panel;
the composite having a barrier layer and a fibrous layer bonded to a first side of the barrier layer, wherein the first side of the barrier layer faces away from the panel composition;
at least portions of fibers in the fibrous layer being exposed from the first side of the barrier layer to adhere another material to the panel;
the barrier layer having a second side facing toward the panel composition; and
the barrier layer being impermeable to the panel composition to isolate the fibrous layer and the fibers in the fibrous layer from contact with the panel composition.

2. A composite for assembly to a panel substrate, comprising:
a barrier layer;
a fibrous layer melt bonded to a first side of the barrier layer;
at least portions of fibers in the fibrous layer being exposed from the first side of the barrier layer to adhere another material to the panel substrate;
the barrier layer having a second side to face toward a polymeric panel composition comprising the panel substrate, while the composite bonds with the panel composition and the first side of the barrier layer faces away from the panel composition for adhering another material to the panel substrate; and
the barrier layer being impermeable to the panel composition to isolate the fibrous layer and the fibers in the fibrous layer from contact with the panel composition.

3. The composite of claim 2 wherein, the barrier layer is chemically compatible with the polymeric panel composition to melt bond therewith, and the fibrous layer is chemically compatible with said another material to melt bond therewith.

4. The composite of claim 2, further comprising:
another fibrous layer bonded to the second side of the barrier layer to bond with the panel composition and to be substantially enveloped by the panel composition.

5. The composite of claim 2, further comprising:
the fibrous layer and said another fibrous layer comprising fiberglass, and
the barrier layer comprising a polymer composition melt bonded to the fiberglass.

6. The composite of claim 2 wherein,
the barrier layer comprises a polymeric first layer coextruded with a polymeric second layer;
the first layer and the second layer having different melt temperatures, respectively;
one of the first layer and the second layer being melt bonded to the fibrous layer at one of the melt temperatures; and
another of the first layer and the second layer being melt bonded to said another fibrous layer at another of the melt temperatures.

7. The composite of claim 2 wherein,
one of the fibrous layer and said another fibrous layer comprising polyester fibers;
another of the fibrous layer and said another fibrous layer comprising polypropylene fibers;
the first layer of the barrier layer comprises polyurethane melt bonded to the polyester fibers; and
the second layer of the barrier layer comprises polypropylene melt bonded to the polypropylene fibers.

8. The composite of claim 3, further comprising:
said barrier layer having a first layer of a first polymeric composition on the first side and a second layer of a second polymeric composition on the second side;
one of the first fibrous layer and a second fibrous layer being melt bonded to said first polymeric composition; and
the other of the first fibrous layer and the second fibrous layer being melt bonded to said second polymeric composition.

9. The composite of claim 8 wherein, said one of the first fibrous layer and the second fibrous layer comprises fibers of polyester, fiberglass, thermoset urethane or a combination thereof; and the second polymeric composition has a melt temperature lower than that of the said first polymeric composition and said fibers.

10. The composite of claim 8 wherein, said one of the first fibrous layer and the second fibrous layer comprises fibers of polyester, fiberglass, thermoset urethane or a combination thereof melt bonded to the first polymeric composition comprising polyurethane.

11. The composite of claim 8, wherein,
said other of the first fibrous layer and the second fibrous layer comprises fibers of polypropylene melt bonded to the second polymeric composition comprising polypropylene.

12. The composite of claim 8, wherein,
said other of the first fibrous layer and the second fibrous layer comprises fibers of polyethylene melt bonded to the second polymeric composition comprising polyethylene.

13. The composite of claim 8, further comprising:
an open mesh scrim bonded to the barrier layer.

14. A method of making a composite comprising:
forming a barrier layer having both sides comprising polyurethane, or having polyurethane on one side and a polymeric resinous composition including, but not limited to; polypropylene or polyethylene on an other side;
bonding a first fibrous layer having fibers of unsaturated polyester to one of the sides comprising polyurethane; and
bonding a second fibrous layer having fibers of polypropylene or polyethylene to another of the sides comprising either polyurethane or the polymeric resinous composition.

15. The method of claim 14, further comprising:
coextruding the polyurethane on the one side and the polymeric resinous composition on the other side.

16. The method of claim 14, further comprising:
bonding a scrim to one or the other sides of the barrier layer.

17. The method of claim 14, further comprising
heating the barrier film to respective melt temperatures of the fibrous layers to melt bond the fibrous layers to the barrier film.

18. A method of making a panel, comprising:
bonding a fibrous layer to a side of a barrier layer to comprise a composite;
imbedding partially the composite in a panel composition of the panel without covering the barrier layer with the panel composition, wherein the barrier layer is impermeable to the panel composition and separates the panel composition from the fibrous layer, and a portion of the fibrous layer is exposed from the barrier layer for adherence of another material to the panel.

19. The method of claim 18, further comprising:
bonding another fibrous layer to another side of the barrier layer; and
imbedding partially the composite in a panel composition of the panel without covering the barrier layer with the panel composition, by embedding said another fibrous layer in the panel composition.

20. The method of claim 19 wherein, imbedding partially the composite in a panel composition of the panel without covering the barrier layer with the panel composition, further comprises partially embedding the barrier layer in the panel composition.
